(19) United States
(12) Patent Application Publication
(10) Pub. No.: US 2020/0382750 A1
(43) Pub. Date: Dec. 3, 2020

(54) METHOD OF CONTROLLING DISPLAY DEVICE, AND DISPLAY DEVICE

(71) Applicant: SEIKO EPSON CORPORATION, Tokyo (JP)

(72) Inventor: Takahiro ANO, Matsumoto-shi (JP)

(73) Assignee: SEIKO EPSON CORPORATION, Tokyo (JP)

(21) Appl. No.: 16/885,830

(22) Filed: May 28, 2020

(30) Foreign Application Priority Data
May 29, 2019 (JP) 2019-100262

(51) Int. Cl. H04N 9/31

(52) U.S. Cl. CPC H04N 9/3185

(57) ABSTRACT

A method of controlling a projector sets a boundary position at which an image display area is divided into a first area and a second area, displays a first image in the first area and a second image different from the first image in the second area, and resets the boundary position when at least one of a size and a position of the image display area changes.

The present application is based on, and claims priority from JP Application Serial Number 2019-100262, filed May 29, 2019, the disclosure of which is hereby incorporated by reference herein in its entirety.

### BACKGROUND

### 1. Technical Field

The present disclosure relates to a method of controlling a display device and a display device.

### 2. Related Art

There has been known a display device for displaying a plurality of images in a single display area (see, e.g., JP-A-2019-15834 (Document 1)).

The display device described in Document 1 includes formation section for forming a display image including a first area where a first image is disposed, and a second area where a second image is disposed, and a display section for displaying the display image on a display surface. The display image includes a specific area. The specific area is divided into the first area and the second area. The formation section determines a position of a boundary between the first area and the second area based on a shape of the first image and a shape of the second image.

In the display device described in Document 1, since when a size or a position of the area (the specific area) where the image is displayed changes is not considered, there is a room for improvement in the process of setting the position of the boundary between the first area and the second area.

For example, when an aspect ratio of the area where an image is displayed changes, there is a possibility that the position of the boundary between the first area and the second area becomes an improper position. Further, when a tool bar is displayed in the area where an image is displayed, and the display position of the tool bar changes, for example, there is a possibility that the position of the boundary between the first area and the second area becomes an improper position.

### SUMMARY

An aspect is directed to a method of controlling a display device including setting a boundary position at which an image display area is divided into a first area and a second area, displaying a first image in the first area, displaying a second image different from the first image in the second area, and resetting the boundary position when at least one of a size and a position of the image display area changes.

The method of controlling a display device described above may be configured to further include setting a part of a displayable area representing an area where an image can be displayed as the image display area.

The method of controlling a display device described above may be configured such that an area obtained by excluding a tool bar from the displayable area is set as the image display area.

The method of controlling a display device described above may be configured such that, as the boundary position, a first boundary position is set so that a size of the first area and a size of the second area become equal to each other.

The method of controlling a display device described above may be configured such that, as the boundary position, a second boundary position is set so that the size of the first area becomes larger than the size of the second area.

The method of controlling a display device described above may be configured to further include resetting the boundary position to the second boundary position from the first boundary position in accordance with a first operation by a user, and resetting the boundary position to the first boundary position from the second boundary position in accordance with a second operation by a user different from the first operation.

The method of controlling a display device described above may be configured to further include inputting the first image from a first input interface, and inputting the second image from a second input interface different from the first input interface.

The method of controlling a display device described above may be configured to further include adjusting the boundary position in accordance with a first aspect ratio as an aspect ratio of the first image and a second aspect ratio as an aspect ratio of the second image.

The method of controlling a display device described above may be configured such that the boundary position is adjusted in accordance with the first aspect ratio and the second aspect ratio so that an area of a region where no image is displayed decreases in the image display area.

The method of controlling a display device described above may be configured such that the boundary position is arranged in parallel to a short-side direction of the image display area.

The method of controlling a display device described above may be configured to further include setting a boundary position at which the image display area is divided into the first area, the second area, a third area, and a fourth area, displaying a third image different from the first image and the second image in the third area, and displaying a fourth image different from the first image, the second image, and the third image in the fourth area, wherein the boundary positions include a boundary position arranged in parallel to a short-side direction of the image display area, and a boundary position arranged in parallel to a long-side direction of the image display area.

Another aspect is directed to a display device including a setting section configured to set a boundary position at which an image display area is divided into a first area and a second area, a display control section configured to display a first image in the first area, and display a second image different from the first image in the second area, and a resetting section configured to reset the boundary position when at least one of a size and a position of the image display area changes.

### BRIEF DESCRIPTION OF THE DRAWINGS

FIG. 1 is a diagram showing an example of a configuration of a projector.

FIG. 2 is a diagram showing an example of a configuration of a control section of the projector.

FIG. 3 is a diagram showing an example of a boundary position corresponding to an aspect ratio of an image display area.

FIG. 4 is a diagram showing an example of a first boundary position corresponding to a display position of a tool bar.

FIG. 5 is a diagram showing an example of a second boundary position corresponding to the display position of the tool bar.

FIG. 6 is a diagram showing an example of the first boundary position corresponding to the display position of the tool bar.

FIG. 7 is a diagram showing an example of a process of adjusting the boundary position.

FIG. 8 is a diagram showing another example of the process of adjusting the boundary position.

FIG. 9 is a flowchart showing an example of a process in a control section.

### DESCRIPTION OF AN EXEMPLARY EMBODIMENT

An embodiment will hereinafter be described with reference to the drawings.

### 1. CONFIGURATION OF PROJECTOR

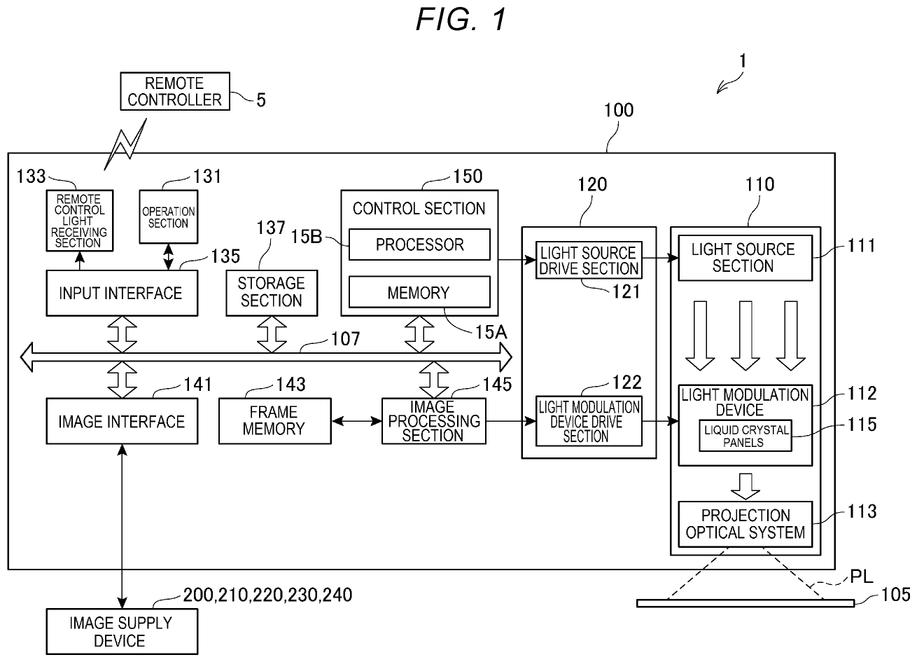

FIG. 1 is a diagram showing a configuration of a projector 100.

A display system 1 is provided with the projector 100 and an image supply device 200. The projector 100 corresponds to an example of a “display device.”

The projector 100 is provided with a projection section 110, and a drive section 120 for driving the projection section 110. The projection section 110 forms an optical image to project the image on a screen 105.

The projection section 110 is provided with a light source section 111, a light modulation device 112, and a projection optical system 113. The drive section 120 is provided with a light source drive section 121 and a light modulation device drive section 122.

The light source section 111 is provided with a lamp such as a halogen lamp, a xenon lamp, or a super-high pressure mercury lamp, or a solid-state light source such as an LED (Light Emitting Diode) or a laser source.

Further, the light source section 111 can also be provided with a reflector and an auxiliary reflector for guiding the light emitted by the light source to the light modulation device 112. Further, the light source section 111 can also be provided with a lens group for improving the optical characteristics of the projection light, a polarization plate, a dimming element for reducing the light intensity of the light emitted by the light source on a path leading to the light modulation device 112, or the like.

The light source drive section 121 is coupled to an internal bus 107, and puts the light source of the light source section 111 on and off in accordance with instructions of the control section 150 similarly coupled to the internal bus 107.

The light modulation device 112 is provided with three liquid crystal panels 115 corresponding respectively to, for example, the three primary colors of R, G, and B. The character R represents red, the character G represents green, and the character B represents blue. In other words, the light modulation device 112 is provided with the liquid crystal panel 115 corresponding to the R colored light, the liquid crystal panel 115 corresponding to the G colored light, and the liquid crystal panel 115 corresponding to the B colored light.

The light emitted by the light source section 111 is separated into colored light beams of the three colors of RGB, and the colored light beams respectively enter the corresponding liquid crystal panels 115. The three liquid crystal panels 115 are each a transmissive liquid crystal panel, and each modulate the transmitted light to generate an image light beam PL. The image light beams PL having been modulated while passing through the respective liquid crystal panels 115 are combined with each other by a combining optical system such as a cross dichroic prism, and are then emitted to the projection optical system 113.

Although when the light modulation device 112 is provided with the liquid crystal panels 115 of a transmissive type as the light modulation elements will be described in the present embodiment, the present embodiment is not limited thereto. The light modulation element can be a liquid crystal panel of a reflective type, or can also be a digital mirror device (or a Digital Micromirror Device).

The light modulation device 112 is driven by the light modulation device drive section 122. The light modulation device drive section 122 is coupled to an image processing section 145.

To the light modulation device drive section 122, there is input image data corresponding to the respective primary colors of R, G, and B from the image processing section 145. The light modulation device drive section 122 converts the image data input thereto into a data signal suitable for the operation of the liquid crystal panel 115. The light modulation device drive section 122 applies a voltage to each pixel of each of the liquid crystal panels 115 based on the data signal thus converted to draw an image on each of the liquid crystal panels 115.

The projection optical system 113 is provided with a lens or a mirror for focusing the image light beams PL having entered the projection optical system 113 on the screen 105. Further, the projection optical system 113 can also be provided with a zoom mechanism for expanding or contracting the image to be projected on the screen 105, a focus adjustment mechanism for performing an adjustment of the focus, and so on.

The projector 100 is further provided with an operation section 131, a remote control light receiving section 133, an input interface 135, a storage section 137, an image interface 141, a frame memory 143, the image processing section 145, and the control section 150. The input interface 135, the storage section 137, the image interface 141, the image processing section 145, and the control section 150 are coupled to each other so as to be able to achieve data communication with each other via the internal bus 107.

The operation section 131 is provided with a variety of buttons and switches disposed on the surface of a housing of the projector 100, and generates an operation signal corresponding to these buttons and switches to output the operation signal to the input interface 135. The operation signal input from the operation section 131 is output by the input interface 135 to the control section 150.

The remote control light receiving section 133 receives an infrared signal transmitted from a remote controller 5, and then decodes the infrared signal thus received to generate the operation signal. The remote control light receiving section 133 outputs the operation signal thus generated to the input interface 135. The operation signal input from the remote control light receiving section 133 is output by the input interface 135 to the control section 150.

The storage section 137 is a nonvolatile storage device such as a hard disk drive or an SSD (Solid-State Drive). The storage section 137 stores a control program to be executed by the control section 150, data having been processed by the control section 150, the image data, and so on.

The image interface 141 is provided with a connector and an interface circuit, and is coupled with wire to an image supply device 200 for supplying the projector 100 with the image data. The image data to be supplied by the image supply device 200 can be still image data, or can also be moving image data. Further, the image supply device 200 can be a reproduction device of an optical disk such as DVD (Digital Versatile Disk), Blu-ray (registered trademark), or the like, or can also be a personal computer.

Further, in the present embodiment, there is described when the projector 100 and the image supply device 200 are coupled to each other with wire, but the projector 100 and the image supply device 200 can also be coupled wirelessly to each other.

The image supply device 200 is coupled to the projector 100. The image supply device 200 supplies the projector 100 with an HDMI (High-Definition Multimedia Interface; registered trademark) signal. The HDMI signal includes the image data, audio data, and so on. The image data can be the image data of a moving image, or can also be the image data of a still image. Further, the audio data can be monaural audio data, or can also be stereo audio data. Further, the audio data can also be surround system audio data using a larger number of audio channels than the stereo system.

As the image supply device 200, it is possible to use, for example, a notebook PC (Personal Computer), a desktop PC, a tablet terminal, a smartphone, and a PDA (personal digital assistant). Further, as the image supply device 200, it is also possible to use a video reproduction device, a DVD player, a Blu-ray disc player, a hard disk recorder, a television tuner device, a set-top box for a CATV (Cable television), a video game device, or the like.

The image interface 141 receives the image signal from the image supply device 200, and then takes out the image data and a sync signal included in the image signal thus received. The image data is data representing a grayscale of each of the pixels for each color component. Further, the sync signal is a signal representing the sync timing, and includes a horizontal sync signal and a vertical sync signal. The image interface 141 outputs the sync signal taken out from the image signal to the control section 150 and the image processing section 145, and outputs the image data to the image processing section 145. The control section 150 determines the timing for executing the process based on the horizontal sync signal and the vertical sync signal to control each section of the projector 100 based on the timing thus determined. The image processing section 145 performs image processing on the image data in sync with the horizontal sync signal and the vertical sync signal, and then outputs the image data on which the image processing has been performed to the light modulation device drive section 122.

In the present embodiment, the image supply device 200 is provided with a first image supply device 210, a second image supply device 220, a third image supply device 230, and a fourth image supply device 240. The first image supply device 210 supplies the image interface 141 with image information representing a first image P1, and the second image supply device 220 supplies the image interface 141 with image information representing a second image P2. The third image supply device 230 supplies the image interface 141 with image information representing a third image P3, and the fourth image supply device 240 supplies the image interface 141 with image information representing a fourth image P4. The first image P1, the second image P2, the third image P3, and the fourth image P4 are different from each other.

The control section 150 is provided with a memory 15A, and a processor 15B.

The memory 15A is a storage device for storing programs and data to be executed by the processor 15B in a nonvolatile manner. The memory 15A is formed of a magnetic storage device, a semiconductor storage element such as a flash ROM, or other types of nonvolatile storage device. Further, the memory 15A can also include a RAM constituting a work area for the processor 15B. The memory 15A stores the data to be processed by the control section 150, and a control program to be executed by the processor 15B.

The processor 15B can be constituted by a single processor, or it is also possible to adopt a configuration in which a plurality of processors functions as the processor 15B. The processor 15B executes the control program to control each section of the projector 100. For example, the processor 15B outputs an execution instruction of the image processing corresponding to the operation received by the operation section 131 or the remote controller 5, and parameters to be used in the image processing to the image processing section 145. The parameters include, for example, geometric correction parameters for correcting a geometric distortion of the image to be projected on the screen 105. Further, the processor 15B controls the light source drive section 121 to control lighting and extinction of the light source section 111, and further controls the luminance of the light source section 111.

The image processing section 145 and the frame memory 143 can be formed of, for example, an integrated circuit. The integrated circuit includes an LSI, an ASIC (Application Specific Integrated Circuit), or a PLD (Programmable Logic Device). The PLD includes, for example, an FPGA (Field-Programmable Gate Array). Further, it is also possible for an analog circuit to be included in a part of the configuration of the integrated circuit, or it is also possible to adopt a combination of the processor and the integrated circuit. The combination of the processor and the integrated circuit is called a micro-controller (MCU), an SoC (System-on-a-chip), a system LSI, a chip set, and so on.

The image data input from the image interface 141 is developed in the frame memory 143 by the image processing section 145. The frame memory 143 is provided with a plurality of banks. Each of the banks has a storage capacity sufficient for writing the image data corresponding to one frame. The frame memory 143 is formed of, for example, an SDRAM (Synchronous Dynamic Random Access Memory).

The image processing section 145 performs image processing such as a resolution conversion process, a resizing process, correction of a distortion aberration, a shape correction process, a digital zoom process, and an adjustment of tint and luminance of the image on the image data developed in the frame memory 143.

Further, the display processing section 145 performs a frame rate conversion process. The frame rate conversion process is a process for converting a frame frequency of the image data to be drawn on the liquid crystal panel 115 into a frequency different from the frame frequency of the image data supplied from the image supply device 200. The frame frequency is the number of images displayed per second as unit time, and corresponds to the frequency of the vertical sync signal. The frame frequency of the image data supplied from the image supply device 200 is referred to as an input frame frequency, and the frame frequency of the image data to be drawn on the liquid crystal panel 115 is referred to as a drawing frequency.

The image processing section 145 generates the vertical sync signal obtained by converting the input frame frequency of the vertical sync signal into the drawing frequency. The vertical sync signal thus generated is referred to as an output sync signal. The image processing section 145 outputs the output sync signal thus generated to the light modulation device drive section 122.

When the input frame frequency, namely the frequency of the vertical sync signal, is 60 Hz, the image processing section 145 generates the output sync signal with, for example, the drawing frequency of 120 Hz obtained by doubling 60 Hz, or the drawing frequency of 240 Hz obtained by quadruplicating 60 Hz. The image processing section 145 outputs the image data retrieved from the frame memory 143 to the light modulation device drive section 122 together with the output sync signal thus generated. The light modulation device drive section 122 performs double speed processing for drawing the image on the liquid crystal panel 115 in sync with the output sync signal input.

Further, the image processing section 145 generates a plurality of sub-frames from one frame of the image data. The sub-frame is image data to be displayed in a display period of the image data corresponding to one frame. The display processing section 145 generates the sub-frames by retrieving the same image data a plurality of times from the frame memory 143. Further, in the present embodiment, the image processing section 145 divides the image data into a plurality of regions, and then generates the sub-frame for each of the regions thus divided into.

### 2. CONFIGURATION OF CONTROL SECTION OF PROJECTOR

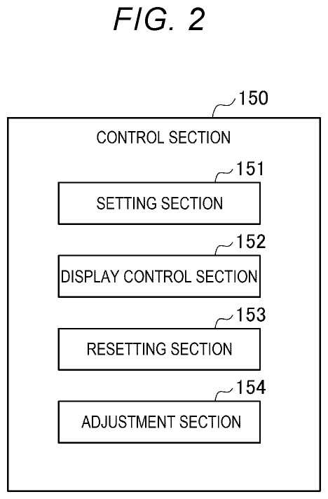

FIG. 2 is a diagram showing a configuration of the control section 150 of the projector 100.

As shown in FIG. 2, the control section 150 of the projector 100 is provided with a setting section 151, a display control section 152, a resetting section 153, and an adjustment section 154. Specifically, the processor 15B of the control section 150 executes the control program stored in the memory 15A to thereby function as the setting section 151, the display control section 152, the resetting section 153, and the adjustment section 154.

The setting section 151 sets a part of a displayable area RA representing an area where an image can be displayed as an image display area RB. Specifically, the setting section 151 sets an area obtained by excluding a tool bar TB from the displayable area RA as the image display area RB. The displayable area RA and the image display area RB each have a rectangular shape. The tool bar TB represents a belt-like area for receiving an operation by the user. In the tool bar TB, there are disposed icons, button objects, and so on. The displayable area RA corresponds to the pixels provided to the liquid crystal panel 115, and the image display area RB corresponds to the pixels in which the tool bar TB is not drawn out of the pixels provided to the liquid crystal panel 115.

Further, the setting section 151 sets a boundary position PB at which the image display area RB is divided into a first area A1 and a second area A2. For example, the setting section 151 sets a first boundary position PB1 as the boundary position PB so that the size of the first area A1 and the size of the second area A2 become equal to each other. Further, for example, the setting section 151 sets a second boundary position PB2 as the boundary position PB so that the size of the first area A1 becomes larger than the size of the second area A2. Further, for example, the setting section 151 sets a third boundary position PB3 as the boundary position PB so that the size of the first area A1 becomes smaller than the size of the second area A2.

The display control section 152 displays the first image P1 in the first area A1, and displays the second image P2 different from the first image P1 in the second area A2. Specifically, the first image P1 is input from a first input interface, and the second image P2 is input from a second input interface different from the first input interface. The first input interface and the second input interface are included in the input interface 135 shown in FIG. 1.

More specifically, the first image P1 is supplied from the first image supply device 210 via the input interface 135. The second image P2 is supplied from the second image supply device 220 via the input interface 135.

Further, the display control section 152 disposes the first image P1 so that an upper end and a lower end of the first image P1, or a left end and a right end thereof are located on the periphery of the first area A1. In other words, the display control section 152 displays the first image P1 in the first area A1 with the largest possible size while keeping the aspect ratio of the first image P1.

Further, the display control section 152 disposes the second image P2 so that an upper end and a lower end of the second image P2, or a left end and a right end thereof are located on the periphery of the second area A2. In other words, the display control section 152 displays the second image P2 in the second area A2 with the largest possible size while keeping the aspect ratio of the second image P2.

The resetting section 153 resets the boundary position PB when at least one of the size and the position of the image display area RB changes.

Further, when the setting section 151 sets the first boundary position PB1 as the boundary position PB, the resetting section 153 resets the boundary position PB from the first boundary position PB1 to the second boundary position PB2 in accordance with the operation by the user. Further, after resetting the boundary position PB, the resetting section 153 resets the boundary position PB from the second boundary position PB2 to the first boundary position PB1 in accordance with the operation by the user. An operation by the user of resetting the boundary position PB from the first boundary position PB1 to the second boundary position PB2 corresponds to an example of a “first operation,” and an operation by the user of resetting the boundary position PB from the second boundary position PB2 to the first boundary position PB1 corresponds to an example of a “second operation.” The operation by the user is received via the remote controller 5 or the operation section 131.

Further, when the setting section 151 sets the second boundary position PB2 as the boundary position PB, the resetting section 153 resets the boundary position PB from the second boundary position PB2 to the third boundary position PB3 in accordance with the operation by the user. Further, after resetting the boundary position PB, the resetting section 153 resets the boundary position PB from the third boundary position PB3 to the second boundary position PB2 in accordance with the operation by the user. An operation by the user of resetting the boundary position PB from the second boundary position PB2 to the third boundary position PB3 corresponds to an example of the “first operation,” and an operation by the user of resetting the boundary position PB from the third boundary position PB3 to the second boundary position PB2 corresponds to an example of the “second operation.” Further, when the setting section 151 sets the third boundary position PB3 as the boundary position PB, the resetting section 153 resets the boundary position PB from the third boundary position PB3 to the first boundary position PB1 in accordance with the operation by the user. Further, after resetting the boundary position PB, the resetting section 153 resets the boundary position PB from the first boundary position PB1 to the third boundary position PB3 in accordance with the operation by the user. An operation by the user of resetting the boundary position PB from the third boundary position PB3 to the first boundary position PB1 corresponds to an example of the “first operation,” and an operation by the user of resetting the boundary position PB from the first boundary position PB1 to the third boundary position PB3 corresponds to an example of the “second operation.”

The adjustment section 154 adjusts the boundary position PB in accordance with a first aspect ratio as the aspect ratio of the first image P1 and a second aspect ratio as the aspect ratio of the second image P2.

Specifically, the adjustment section 154 adjusts the boundary position PB in accordance with the first aspect ratio and the second aspect ratio so that the area of the region where no image is displayed decreases in the image display area RB.

### 3. SPECIFIC EXAMPLE OF PROCESS OF CONTROL SECTION OF PROJECTOR

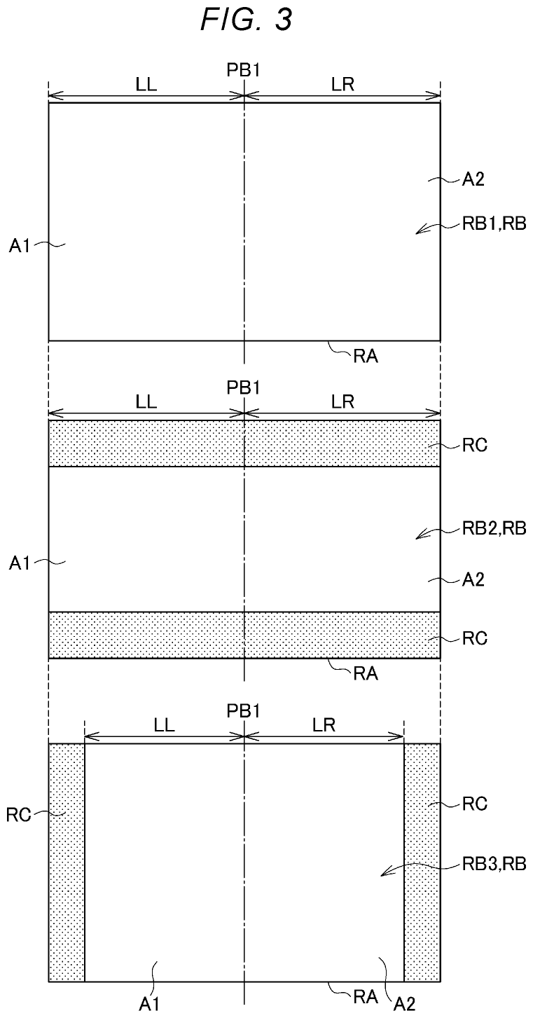

Then, a specific example of the process of the control section 150 of the projector 100 will be described with reference to FIG. 3 through FIG. 8.

### 3-1. Influence of Aspect Ratio of Image Display Area

FIG. 3 is a diagram showing an example of the boundary position PB corresponding to the aspect ratio of the image display area RB. In the present embodiment, when the aspect ratio of the displayable area RA is 16:10 will be described. Further, in the present embodiment, the displayable area RA corresponds to a display surface of the screen 105. Further, in FIG. 3, there is described when the tool bar TB is not displayed.

In the diagram shown in an upper part of FIG. 3, since the aspect ratio of an image display area RB1 is the same as the aspect ratio of the displayable area RA, the image display area RB1 coincides with the displayable area RA. In other words, the aspect ratio of the image display area RB1 is 16:10. The image display area RB1 represents an example of the image display area RB.

The setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB1.

In the drawing shown in a middle part of FIG. 3, since an image display area RB2 is more landscape-oriented than the displayable area RA, non-projection areas RC are disposed in upper and lower regions of the displayable area RA. The non-projection areas RC each correspond to a region where the image light PL is not projected in the displayable area RA. In other words, the non-projection area RC represents a region outside the image display area RB2 in the displayable area RA.

Specifically, the aspect ratio of the image display area RB2 is, for example, 16:6. The image display area RB2 represents an example of the image display area RB.

The setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB2.

In the drawing shown in a lower part of FIG. 3, since an image display area RB3 is more portrait-oriented than the displayable area RA, non-projection areas RC are disposed in right and left regions of the displayable area RA. The non-projection areas RC each correspond to a region where the image light PL is not projected in the displayable area RA. In other words, the non-projection area RC represents a region outside the image display area RB3 in the displayable area RA.

Specifically, the aspect ratio of the image display area RB3 is, for example, 4:3. The image display area RB3 represents an example of the image display area RB.

The setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB3.

As described with reference to FIG. 3, it is possible to set the first boundary position PB1 in accordance with the aspect ratio of the image display area RB so that the size of the first area A1 and the size of the second area A2 become equal to each other.

### 3-2. Influence of Display Position of Tool Bar

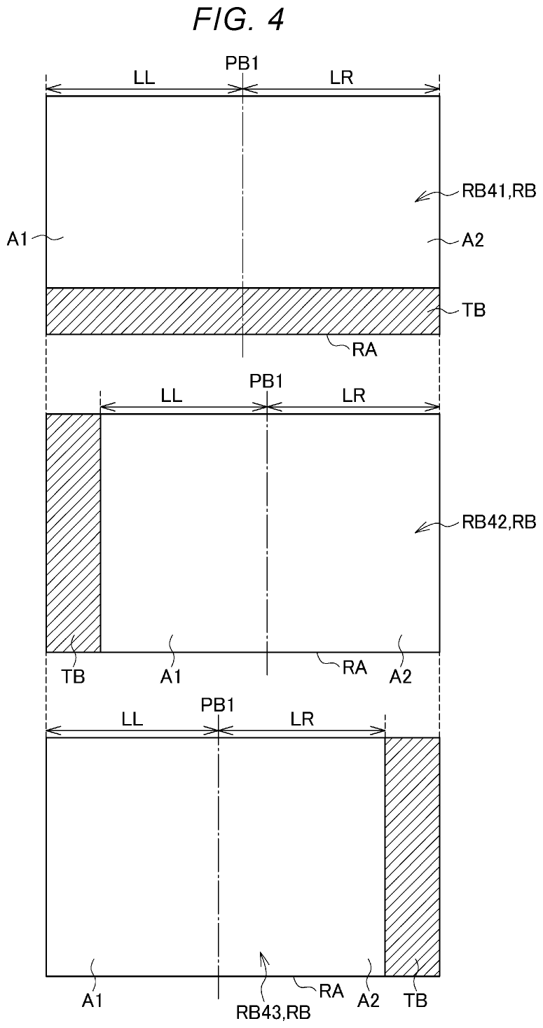

FIG. 4 is a diagram showing an example of the first boundary position PB1 corresponding to the display position of the tool bar TB. In FIG. 4, there is described when the aspect ratio of the displayable area RA is 16:10, and the displayable area RA does not include the non-projection area RC. In other words, there is described when the displayable area RA is constituted by an area for the tool bar TB and the image display area RB.

In the diagram shown in an upper part of FIG. 4, the tool bar TB is arranged along the long side of the displayable area RA at a lower end of the displayable area RA.

In this case, the setting section 151 sets an area obtained by excluding the toolbar TB from the displayable area RA as an image display area RB41. As a result, the image display area RB4l is more landscape-oriented than the displayable area RA. The image display area RB4l represents an example of the image display area RB.

Further, the setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB41.

In the diagram shown in a middle part of FIG. 4, the tool bar TB is arranged along the short side of the displayable area RA at a left end of the displayable area RA.

In this case, the setting section 151 sets an area obtained by excluding the tool bar TB from the displayable area RA as an image display area RB42. As a result, the image display area RB42 is more portrait-oriented than the displayable area RA. The image display area RB42 represents an example of the image display area RB.

Further, the setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB42.

In the diagram shown in a lower part of FIG. 4, the tool bar TB is arranged along the short side of the displayable area RA at a right end of the displayable area RA.

In this case, the setting section 151 sets an area obtained by excluding the tool bar TB from the displayable area RA as an image display area RB43. As a result, the image display area RB43 is more portrait-oriented than the displayable area RA. The image display area RB43 represents an example of the image display area RB.

Further, the setting section 151 sets the first boundary position PB1 as the boundary position PB so that the size of the first area A1 and the size of the second area A2 become equal to each other. In other words, the first boundary position PB1 is arranged linearly along a vertical direction so that the size LL in a horizontal direction of the first area A1 coincides with the size LR in the horizontal direction of the second area A2. The vertical direction represents a direction parallel to a short-side direction of the image display area RB43.

As described with reference to FIG. 4, it is possible to set the first boundary position PB1 so that the size of the first area A1 and the size of the second area A2 become equal to each other when the tool bar TB is arranged in the displayable area RA.

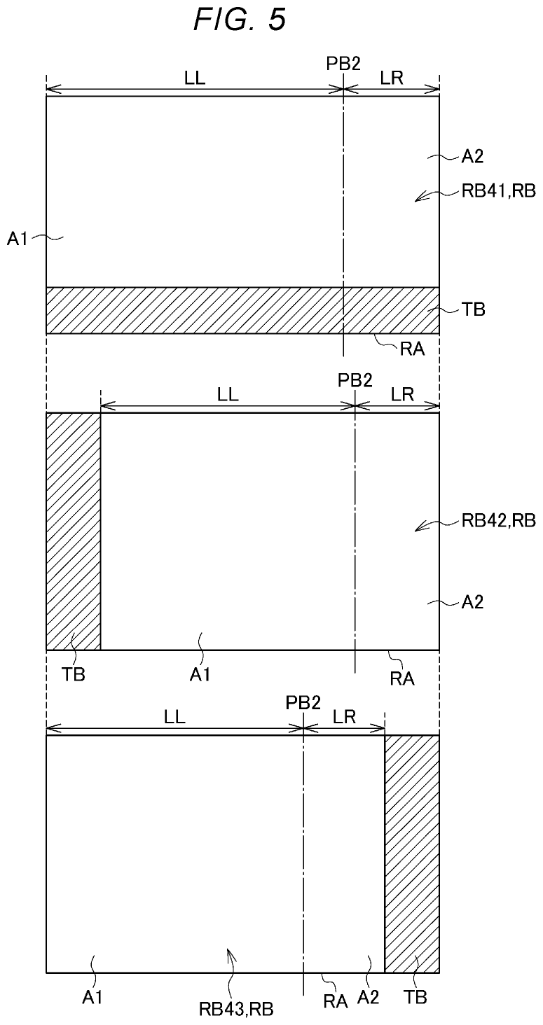

FIG. 5 is a diagram showing an example of the second boundary position PB2 corresponding to the display position of the tool bar TB. In FIG. 5, there is described when the aspect ratio of the displayable area RA is 16:10, and the displayable area RA does not include the non-projection area RC. In other words, there is described when the displayable area RA is constituted by an area for the tool bar TB and the image display area RB.

In the diagram shown in an upper part of FIG. 5, the tool bar TB is arranged along the long side of the displayable area RA at a lower end of the displayable area RA.

In this case, the setting section 151 sets an area obtained by excluding the toolbar TB from the displayable area RA as the image display area RB41. As a result, the image display area RB41 is more landscape-oriented than the displayable area RA. The image display area RB41 represents an example of the image display area RB.

Further, the setting section 151 sets the second boundary position PB2 as the boundary position PB so that the size of the first area A1 becomes larger than the size of the second area A2. In other words, the second boundary position PB2 is arranged linearly along the vertical direction so that the size LL in the horizontal direction of the first area A1 becomes longer than the size LR in the horizontal direction of the second area A2. The vertical direction represents a direction parallel to a short-side direction of the image display area RB41.

For example, the size LL is 3 times as large as the size LR.

In the diagram shown in a middle part of FIG. 5, the tool bar TB is arranged along the short side of the displayable area RA at a left end of the displayable area RA.

In this case, the setting section 151 sets an area obtained by excluding the toolbar TB from the displayable area RA as the image display area RB42. As a result, the image display area RB42 is more portrait-oriented than the displayable area RA. The image display area RB42 represents an example of the image display area RB.

Further, the setting section 151 sets the second boundary position PB2 as the boundary position PB so that the size of the first area A1 becomes larger than the size of the second area A2. In other words, the second boundary position PB2 is arranged linearly along the vertical direction so that the size LL in the horizontal direction of the first area A1 becomes longer than the size LR in the horizontal direction of the second area A2. The vertical direction represents a direction parallel to a short-side direction of the image display area RB42.

For example, the size LL is 3 times as large as the size LR.

In the diagram shown in a lower part of FIG. 5, the tool bar TB is arranged along the short side of the displayable area RA at the right end of the displayable area RA.

In this case, the setting section 151 sets an area obtained by excluding the toolbar TB from the displayable area RA as the image display area RB43. As a result, the image display area RB43 is more portrait-oriented than the displayable area RA. The image display area RB43 represents an example of the image display area RB.

Further, the setting section 151 sets the second boundary position PB2 as the boundary position PB so that the size of the first area A1 becomes larger than the size of the second area A2. In other words, the second boundary position PB2 is arranged linearly along the vertical direction so that the size LL in the horizontal direction of the first area A1 becomes longer than the size LR in the horizontal direction of the second area A2. The vertical direction represents a direction parallel to the short-side direction of the image display area RB43.

For example, the size LL is 3 times as large as the size LR.

As described with reference to FIG. 5, it is possible to set the second boundary position PB2 so that the size of the first area A1 becomes larger than the size of the second area A2. In substantially the same manner, it is possible to set the third boundary position PB3 so that the size of the second area A2 becomes larger than the size of the first area A1.

3-3. Boundary Position when Performing Quartering

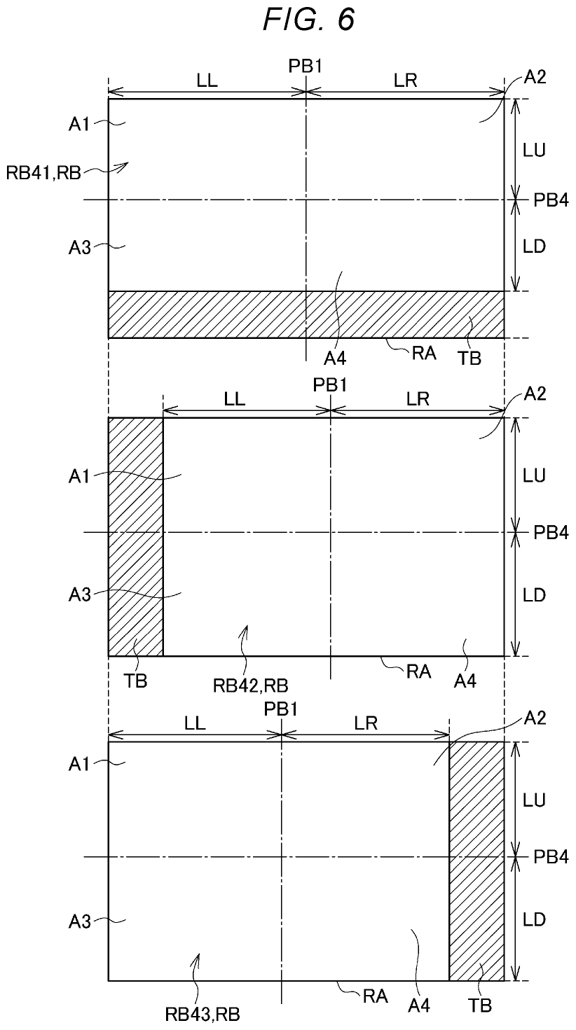

FIG. 6 is a diagram showing an example of the first boundary position PB1 and a first boundary position PB4 corresponding to the display position of the tool bar TB.

As shown in FIG. 6, the setting section 151 sets the boundary positions PB at which the image display area RB is divided into the first area A1, the second area A2, a third area A3, and a fourth area A4. For example, the setting section 151 sets the first boundary position PB1 and the first boundary position PB4 as the boundary positions PB so that the size of the first area A1, the size of the second area A2, the size of the third area A3, and the size of the fourth area A4 become equal to each other.

The first boundary position PB1 is arranged linearly along the short-side direction of the image display area RB, and the first boundary position PB4 is arranged linearly along a long-side direction of the image display area RB.

In the diagram shown in an upper part of FIG. 6, the tool bar TB is arranged along the long side of the displayable area RA at the lower end of the displayable area RA.

In this case, the setting section 151 sets an area obtained by excluding the toolbar TB from the displayable area RA as the image display area RB41. As a result, the image display area RB41 is more landscape-oriented than the displayable area RA.

Further, the setting section 151 sets the first boundary position PB1 so that the size of the first area A1 and the size of the second area A2 become equal to each other. In other words, the first boundary position PB1 is arranged linearly along the vertical direction so that the size LL in the horizontal direction of the first area A1 coincides with the size LR in the horizontal direction of the second area A2. The vertical direction represents a direction parallel to the short-side direction of the image display area RB41.

Further, the setting section 151 sets the first boundary position PB4 so that the size of the first area A1 and the size of the third area A3 become equal to each other. In other words, the first boundary position PB4 is arranged linearly along the horizontal direction so that the size LU in the vertical direction of the first area A1 coincides with the size LD in the vertical direction of the third area A3. The horizontal direction represents a direction parallel to a long-side direction of the image display area RB41.

In the diagram shown in a middle part of FIG. 6, the tool bar TB is arranged along the short side of the displayable area RA at the left end of the displayable area RA.

In this case, the setting section 151 sets an area obtained by excluding the toolbar TB from the displayable area RA as the image display area RB42. As a result, the image display area RB42 is more portrait-oriented than the displayable area RA.

Further, the setting section 151 sets the first boundary position PB1 so that the size of the first area A1 and the size of the second area A2 become equal to each other. In other words, the first boundary position PB1 is disposed linearly along the vertical direction so that the size LL in the horizontal direction of the first area A1 coincides with the size LR in the horizontal direction of the second area A2. The vertical direction represents a direction parallel to a short-side direction of the image display area RB42.

Further, the setting section 151 sets the first boundary position PB4 so that the size of the first area A1 and the size of the third area A3 become equal to each other. In other words, the first boundary position PB4 is arranged linearly along the horizontal direction so that the size LU in the vertical direction of the first area A1 coincides with the size LD in the vertical direction of the third area A3. The horizontal direction represents a direction parallel to a long-side direction of the image display area RB42.

In the diagram shown in a lower part of FIG. 6, the tool bar TB is arranged along the short side of the displayable area RA at the right end of the displayable area RA.

In this case, the setting section 151 sets an area obtained by excluding the toolbar TB from the displayable area RA as the image display area RB43. As a result, the image display area RB43 is more portrait-oriented than the displayable area RA.

Further, the setting section 151 sets the first boundary position PB1 so that the size of the first area A1 and the size of the second area A2 become equal to each other. In other words, the first boundary position PB1 is arranged linearly along the vertical direction so that the size LL in the horizontal direction of the first area A1 coincides with the size LR in the horizontal direction of the second area A2. The vertical direction represents a direction parallel to a short-side direction of the image display area RB43.

Further, the setting section 151 sets the first boundary position PB4 so that the size of the first area A1 and the size of the third area A3 become equal to each other.

In other words, the first boundary position PB4 is arranged linearly along the horizontal direction so that the size LU in the vertical direction of the first area A1 coincides with the size LD in the vertical direction of the third area A3. The horizontal direction represents a direction parallel to a long-side direction of the image display area RB43.

As described with reference to FIG. 6, it is possible to set the first boundary position PB1 and the first boundary position PB4 in accordance with the display position of the tool bar TB so that the first area A1 through the fourth area A4 become the same in size as each other.

3-4. Process of Adjusting Boundary Position

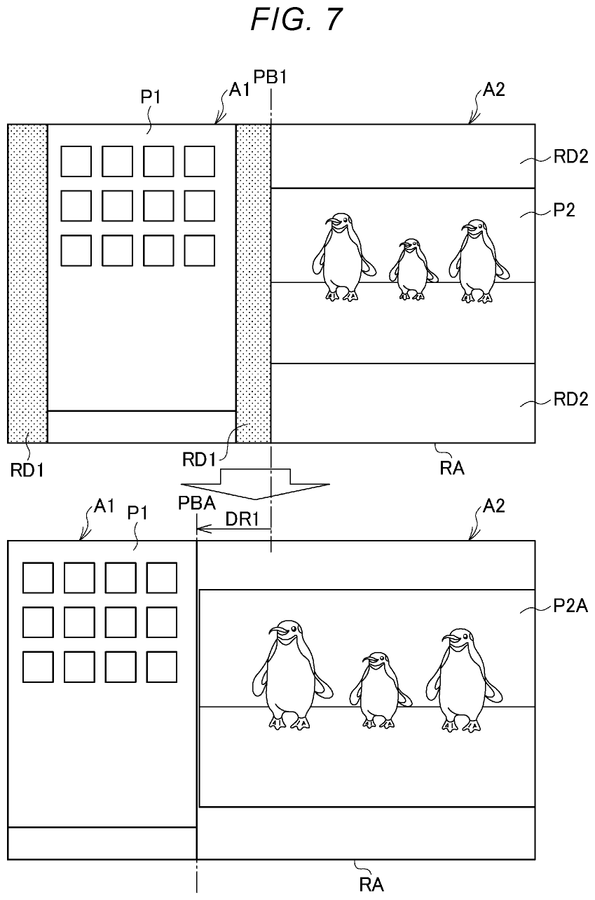

FIG. 7 is a diagram showing an example of a process of adjusting the boundary position PB by the adjustment section 154.

The diagram shown in an upper part of FIG. 7 is an example of an image diagram when the setting section 151 sets the first boundary position PB1, and the display control section 152 displays the first image P1 in the first area A1, and the second image P2 different from the first image P1 in the second area A2.

The first image P1 is an image more portrait-oriented than the first area A1, and the second image P2 is an image more landscape-oriented than the second area A2.

The adjustment section 154 adjusts the first boundary position PB1 in accordance with the first aspect ratio as the aspect ratio of the first image P1 and the second aspect ratio as the aspect ratio of the second image P2.

Specifically, the adjustment section 154 adjusts the boundary position PB in accordance with the first aspect ratio and the second aspect ratio so that the area of a non-display region RD decreases in the image display area RB. The non-display region RD represents the region where no image is displayed.

More specifically, in the first area A1, there are disposed non-display regions RD1 respectively on the right side and the left side of the first image P1, and in the second area A2, there are disposed non-display regions RD2 respectively on the upper side and the lower side of the second image P2. The non-display region RD1 and the non-display region RD2 each correspond to an example of the non-display region RD.

In this case, as shown in the diagram in a lower part of FIG. 7, the adjustment section 154 adjusts the boundary position PB to a boundary position PBA from the first boundary position PB1. Specifically, the adjustment section 154 moves the first boundary position PB1 leftward as much as a distance DR1 to thereby adjust the boundary position PB to the boundary position PBA from the first boundary position PB1.

As a result, the size in the horizontal direction of the first area A1 decreases as much as the distance DR1, and the size in the horizontal direction of the second area A2 increases as much as the distance DR1.

Then, the display control section 152 displays a second image P2A, which is obtained by expanding the second image P2 so that the non-display region RD in the horizontal direction does not occur in the second area A2 while keeping the aspect ratio in the second aspect ratio, in the second area A2.

As described with reference to FIG. 7, by adjusting the boundary position PB so that the areas of the non-display regions RD decrease, it is possible to expand the second image P2 without contracting the first image P1.

It should be noted that when the first aspect ratio and the second aspect ratio in FIG. 7 are reversed, it is possible to expand the first image P1 without contracting the second image P2 by adjusting the boundary position PB so that the areas of the non-display regions RD decrease.

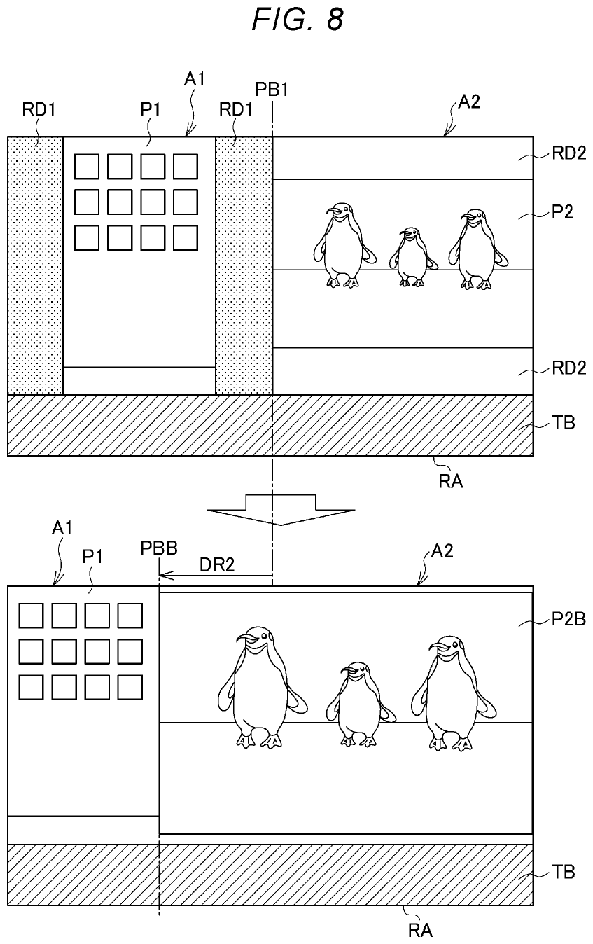

FIG. 8 is a diagram showing an example of another process of adjusting the boundary position PB by the adjustment section 154. FIG. 8 is different in the point that the tool bar TB is displayed compared to FIG. 7.

The diagram shown in an upper part of FIG. 8 is an example of an image diagram when the setting section 151 sets the first boundary position PB1, and the display control section 152 displays the first image P1 in the first area A1, and the second image P2 different from the first image P1 in the second area A2.

The first image P1 is an image more portrait-oriented than the first area A1, and the second image P2 is an image more landscape-oriented than the second area A2.

The adjustment section 154 adjusts the first boundary position PB1 in accordance with the first aspect ratio as the aspect ratio of the first image P1 and the second aspect ratio as the aspect ratio of the second image P2.

Specifically, the adjustment section 154 adjusts the boundary position PB in accordance with the first aspect ratio and the second aspect ratio so that the area of the non-display region RD decreases in the image display area RB. The non-display region RD represents the region where on image is displayed.

More specifically, in the first area A1, there are disposed non-display regions RD1 respectively on the right side and the left side of the first image P1, and in the second area A2, there are disposed non-display regions RD2 respectively on the upper side and the lower side of the second image P2. The non-display region RD1 and the non-display region RD2 each correspond to an example of the non-display region RD.

In this case, as shown in the diagram in a lower part of FIG. 8, the adjustment section 154 adjusts the boundary position PB to a boundary position PBB from the first boundary position PB1. Specifically, the adjustment section 154 moves the first boundary position PB1 leftward as much as a distance DR2 to thereby adjust the boundary position PB to the boundary position PBB from the first boundary position PB1.

As a result, the size in the horizontal direction of the first area A1 decreases as much as the distance DR2, and the size in the horizontal direction of the second area A2 increases as much as the distance DR2. The distance DR2 is longer than the distance DR1 shown in FIG. 7.

Then, the display control section 152 displays a second image P2B, which is obtained by expanding the second image P2 so that the non-display region RD in the horizontal direction does not occur in the second area A2 while keeping the aspect ratio in the second aspect ratio, in the second area A2.

As described with reference to FIG. 8, even when the tool bar TB is displayed, it is possible to expand the second image P2 without contracting the first image P1 by adjusting the boundary position PB so that the areas of the non-display regions RD decrease.

It should be noted that when the first aspect ratio and the second aspect ratio in FIG. 8 are reversed, it is possible to expand the first image P1 without contracting the second image P2 by adjusting the boundary position PB so that the areas of the non-display regions RD decrease.

As described with reference to FIG. 7 and FIG. 8, when the three conditions (condition A through condition C) described below are fulfilled, it is possible to expand the second image P2 without contracting the first image P1, or it is possible to expand the first image P1 without contracting the second image P2.

Condition A: the setting section 151 sets the first boundary position PB1 as the boundary position PB.

Condition B: one of the first image P1 and the second image P2 is an image more portrait-oriented than the first area A1.

Condition C: the other of the first image P1 and the second image P2 is an image more landscape-oriented than the first area A1.

### 4. PROCESS OF CONTROL SECTION

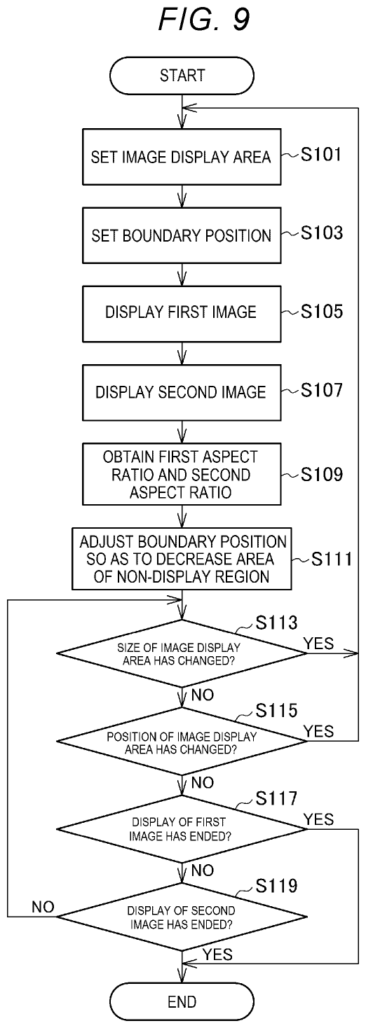

FIG. 9 is a flowchart showing an example of a process of the control section 150.

It should be noted that in FIG. 9, there is described when the setting section 151 sets the boundary position PB at which the image display area RB is divided into the first area A1 and the second area A2.

Further, in FIG. 9, for the sake of convenience, there is described when the operation by the user of instructing resetting of the boundary position PB is not made. The operation by the user of instructing resetting of the boundary position PB means an operation of instructing resetting of the boundary position RB, for example, to the second boundary position PB2 from the first boundary position PB1.

As shown in FIG. 9, firstly in the step S101, the setting section 151 sets a part of the displayable area RA representing the area where an image can be displayed as the image display area RB. Specifically, the setting section 151 sets the area obtained by excluding the tool bar TB from the displayable area RA as the image display area RB.

Then, in the step S103, the setting section 151 sets the boundary position PB at which the image display area RB is divided into the first area A1 and the second area A2. For example, the setting section 151 sets the first boundary position PB1 as the boundary position PB so that the size of the first area A1 and the size of the second area A2 become equal to each other.

Then, in the step S105, the display control section 152 displays the first image P1 in the first area A1. Specifically, the display control section 152 displays the first image P1 in the first area A1 with the largest possible size while keeping the aspect ratio of the first image P1.

Then, in the step S107, the display control section 152 displays the second image P2 in the second area A2. Specifically, the display control section 152 displays the second image P2 in the second area A2 with the largest possible size while keeping the aspect ratio of the second image P2.

Then, in the step S109, the adjustment section 154 obtains the first aspect ratio as the aspect ratio of the first image P1 and the second aspect ratio as the aspect ratio of the second image P2.

Then, in the step S111, the adjustment section 154 adjusts the boundary position PB in accordance with the first aspect ratio and the second aspect ratio so that the area of the non-display region RD decreases in the image display area RB.

Then, in the step S113, the resetting section 153 determines whether or not the size of the image display area RB has changed.

When the resetting section 153 determines that the size of the image display area RB has changed (YES in the step S113), the process returns to the step S101. Then, in the step S101, the resetting section 153 resets a part of the displayable area RA representing the area where an image can be displayed as the image display area RB, and in the step S103, the resetting section 153 resets the boundary position PB. Subsequently, the process in the step S105 and the following steps is performed.

When the resetting section 153 determines that the size of the image display area RB has not changed (NO in the step S113), the process proceeds to the step S115.

Then, in the step S115, the resetting section 153 determines whether or not the position of the image display area RB has changed.

When the resetting section 153 determines that the position of the image display area RB has changed (YES in the step S115), the process returns to the step S101. Then, in the step S101, the resetting section 153 resets a part of the displayable area RA representing the area where an image can be displayed as the image display area RB, and in the step S103, the resetting section 153 resets the boundary position PB. Subsequently, the process in the step S105 and the following steps is performed.

When the resetting section 153 determines that the position of the image display area RB has not changed (NO in the step S115), the process proceeds to the step S117.

Then, in the step S117, the display control section 152 determines whether or not the display of the first image P1 in the first area A1 has ended.

When the display control section 152 determines that the display of the first image P1 in the first area A1 has ended (YES in the step S117), the process of the control section 150 ends. When the display control section 152 determines that the display of the first image P1 in the first area A1 has not ended (NO in the step S117), the process proceeds to the step S119.

Then, in the step S119, the display control section 152 determines whether or not the display of the second image P2 in the second area A2 has ended.

When the display control section 152 determines that the display of the second image P2 in the second area A2 has not ended (NO in the step S119), the process returns to the step S113. When the display control section 152 determines that the display of the second image P2 in the second area A2 has ended (YES in the step S119), the process of the control section 150 ends.

### 5. FUNCTIONS AND ADVANTAGES OF PRESENT EMBODIMENT

As described hereinabove with reference to FIG. 1 through FIG. 9, the method of controlling the projector 100 according to the present embodiment sets the boundary position PB at which the image display area RB is divided into the first area A1 and the second area A2, displays the first image P1 in the first area A1 and the second image P2 different from the first image P1 in the second area A2, and resets the boundary position PB when at least one of the size and the position of the image display area RB changes.

Therefore, since the boundary position PB is reset when at least one of the size and the position of the image display area RB changes, resetting to the appropriate boundary position PB can be achieved. Therefore, it is possible to appropriately set the boundary position PB.

Further, the method of controlling the projector 100 sets a part of a displayable area RA representing an area where an image can be displayed as an image display area RB.

Therefore, it is possible to appropriately set the image display area RB.

Further, the method of controlling the projector 100 sets an area obtained by excluding the tool bar TB from the displayable area RA as the image display area RB.

Therefore, it is possible to appropriately set the image display area RB.

Further, the method of controlling the projector 100 sets the first boundary position PB1 as the boundary position PB so that the size of the first area A1 and the size of the second area A2 become equal to each other.

Therefore, it is possible to set the first boundary position PB1 desired by the user as the boundary position PB. Therefore, it is possible to enhance the convenience of the user.

Further, the method of controlling the projector 100 sets the second boundary position PB2 as the boundary position PB so that the size of the first area A1 becomes larger than the size of the second area A2.

Therefore, it is possible to set the second boundary position PB2 desired by the user as the boundary position PB. Therefore, it is possible to enhance the convenience of the user.

Further, the method of controlling the projector 100 resets the boundary position PB to the second boundary position PB2 from the first boundary position PB1 in accordance with the first operation by the user, and resets the boundary position PB to the first boundary position PB1 from the second boundary position PB2 in accordance with the second operation by the user different from the first operation.

Therefore, it is possible to reset the boundary position PB to the second boundary position PB2 from the first boundary position PB1 in accordance with the first operation by the user, and reset the boundary position PB to the first boundary position PB1 from the second boundary position PB2 in accordance with the second operation by the user different from the first operation. Therefore, it is possible to enhance the convenience of the user.

Further, in the method of controlling the projector 100, the first image P1 is input from the first input interface, and the second image P2 is input from the second input interface different from the first input interface.

Therefore, it is possible to display each of the first image P1 and the second image P2 with a simple configuration.

Further, the method of controlling the projector 100 adjusts the boundary position PB in accordance with the first aspect ratio as the aspect ratio of the first image P1 and the second aspect ratio as the aspect ratio of the second image P2.

Therefore, since the boundary position PB is adjusted in accordance with the first aspect ratio and the second aspect ratio, it is possible to appropriately adjust the boundary position PB.

Further, the method of controlling the projector 100 adjusts the boundary position PB in accordance with the first aspect ratio and the second aspect ratio so that the area of the region where an image is not displayed decreases in the image display area RB.

Therefore, since the boundary position PB is adjusted so that the area of the region where the image is not displayed decreases in the image display area RB, it is possible to appropriately adjust the boundary position PB.

Further, in the method of controlling the projector 100, the boundary position PB is arranged in parallel to the short-side direction of the image display area RB.

Therefore, since the boundary position PB is arranged in parallel to the short-side direction of the image display area RB, it is possible to appropriately set the boundary position PB.

Further, the method of controlling the projector 100 sets the boundary positions PB at which the image display area RB is divided into the first area A1, the second area A2, the third area A3, and the fourth area A4, displays the third image P3 different from the first image P1 and the second image P2 in the third area A3, and displays the fourth image P4 different from the first image P1, the second image P2, and the third image P3 in the fourth area A4, wherein the boundary positions PB include a boundary position arranged in parallel to the short-side direction of the image display area RB, and a boundary position arranged in parallel to the long-side direction of the image display area RB.

Therefore, since the boundary positions PB include the boundary position arranged in parallel to the short-side direction of the image display area RB and the boundary position arranged in parallel to the long-side direction of the image display area RB, it is possible to set the boundary positions PB at which the image display area RB is divided into the first area A1, the second area A2, the third area A3, and the fourth area A4.

Further, the projector 100 according to the present embodiment is provided with the setting section 151 for setting the boundary position PB at which the image display area RB is divided into the first area A1 and the second area A2, the display control section 152 for displaying the first image P1 in the first area A1 and the second image P2 different from the first image P1 in the second area A2, and the resetting section for resetting the boundary position PB when at least one of the size and the position of the image display area RB changes.

Therefore, since the resetting section 153 resets the boundary position PB when at least one of the size and the position of the image display area RB changes, resetting to the appropriate boundary position PB can be achieved. Therefore, it is possible to appropriately set the boundary position PB.

### 6. OTHER EMBODIMENTS

The present embodiment described above is a preferred embodiment. It should be noted that the embodiment described above is not a limitation, but a variety of modified implementation are possible within the scope or the spirit.

In the present embodiment, there is described when dividing the image display area RB into the two areas, and when dividing the image display area RB into the four areas, but the embodiment of the present disclosure is not limited to these cases. It is also possible to adopt a configuration of dividing the image display area RB into three areas, or to adopt a configuration of dividing the image display area RB into five or more areas.

Further, in the present embodiment, there is described when a single tool bar TB is displayed in the displayable area RA, but the embodiment of the present disclosure is not limited to this case. It is also possible to adopt a configuration in which two or more tool bars TB are displayed in the displayable area RA.

Further, in the present embodiment, there is described when the second image P2 is different from the first image, but it is also possible for the second image P2 to be the same image as the first image.

Further, each of the functional sections shown in FIG. 1 and FIG. 2 represents the functional configuration, and the specific implementation configuration is not particularly limited. In other words, it is not necessarily required to install the hardware corresponding individually to each of the functional sections, but it is obviously possible to adopt a configuration of realizing the functions of the plurality of functional sections by a single processor executing a program. Further, a part of the function realized by software in the embodiment described above can also be realized by hardware, or a part of the function realized by hardware can also be realized by software. Besides the above, the specific detailed configuration of each of other sections of the projector 100 can arbitrarily be modified within the scope or the spirit.

Further, the processing unit of the flowchart shown in FIG. 9 is obtained by dividing the process of the projector 100 in accordance with major processing contents in order to make the process of the projector 100 easy to understand. The way of division or the names of the processing units shown in the flowchart in FIG. 9 are not limitations, and it is also possible to divide the process into a larger number of processing units, or it is also possible to divide the process so that one processing unit includes a larger amount of process in accordance with the processing contents. Further, the processing sequence of the flowchart described above is not limited to the illustrated example.

Further, the method of controlling the projector 100 can be realized by making the processor 15B provided to the projector 100 execute the program corresponding to the method of controlling the projector 100. Further, it is also possible to recode the program on a recording medium storing the program in a computer readable manner. As the recording medium, there can be used a magnetic or optical recording medium, or a semiconductor memory device. Specifically, there can be cited a portable or rigid recording medium such as a flexible disk, an HDD (Hard Disk Drive), a CD-ROM (Compact Disc Read Only Memory), a DVD (Digital Versatile Disc), a Blu-ray (registered trademark) disc, a magnetooptic disc, a flash memory, or a card-type recording medium. Further, the recording medium can also be a RAM (Random Access Memory) as an internal storage device provided to the projector 100, or a nonvolatile storage device such as a ROM (Read Only Memory) or the HDD. Further, it is also possible to realize the method of controlling the projector 100 by storing the program corresponding to the method of controlling the projector 100 in a server device or the like in advance, and then downloading the program from the server device to the projector 100.

What is claimed is:

1. A method of controlling a display device, comprising:
setting a boundary position at which an image display area is divided into a first area and a second area;
displaying a first image in the first area;
displaying a second image different from the first image in the second area; and
resetting the boundary position when at least one of a size and a position of the image display area changes.

2. The method of controlling the display device according to claim 1, further comprising:
setting a part of a displayable area representing an area where an image can be displayed as the image display area.

3. The method of controlling the display device according to claim 2, wherein
an area obtained by excluding a tool bar from the displayable area is set as the image display area.

4. The method of controlling the display device according to claim 1, wherein
as the boundary position, a first boundary position is set so that a size of the first area and a size of the second area become equal to each other.

5. The method of controlling the display device according to claim 4, wherein
as the boundary position, a second boundary position is set so that the size of the first area becomes larger than the size of the second area.

6. The method of controlling the display device according to claim 5, further comprising:
resetting the boundary position to the second boundary position from the first boundary position in accordance with a first operation by a user; and
resetting the boundary position to the first boundary position from the second boundary position in accordance with a second operation by a user different from the first operation.

7. The method of controlling the display device according to claim 1, further comprising:
inputting the first image from a first input interface; and
inputting the second image from a second input interface different from the first input interface.

8. The method of controlling the display device according to claim 1, further comprising:
adjusting the boundary position in accordance with a first aspect ratio as an aspect ratio of the first image and a second aspect ratio as an aspect ratio of the second image.

9. The method of controlling the display device according to claim 8, further comprising
adjusting the boundary position in accordance with the first aspect ratio and the second aspect ratio so that an area of a region where no image is displayed decreases in the image display area.

10. The method of controlling the display device according to claim 9, wherein
the boundary position is arranged in parallel to a short-side direction of the image display area.

11. The method of controlling the display device according to claim 1, further comprising:
setting a boundary position at which the image display area is divided into the first area, the second area, a third area, and a fourth area;
displaying a third image different from the first image and the second image in the third area; and
displaying a fourth image different from the first image, the second image, and the third image in the fourth area, wherein
the boundary positions include a boundary position arranged in parallel to a short-side direction of the image display area, and a boundary position arranged in parallel to a long-side direction of the image display area.

12. A display device comprising:
a setting section configured to set a boundary position at which an image display area is divided into a first area and a second area;
a display control section configured to display a first image in the first area, and display a second image different from the first image in the second area; and
a resetting section configured to reset the boundary position when at least one of a size and a position of the image display area changes.
